(19) United States
(12) Patent Application Publication
(10) Pub. No.: US 2017/0131417 A1
(43) Pub. Date: May 11, 2017

(54) SYSTEMS AND METHODS FOR SEISMIC EXPLORATION IN DIFFICULT OR CONSTRAINED AREAS

(71) Applicant: CGG SERVICES SAS, Massy Cedex (FR)

(72) Inventors: Thomas BIANCHI, Paris (FR); John James SALLAS, Plano, TX (US)

(21) Appl. No.: 15/317,284

(22) PCT Filed: Jun. 19, 2014
(86) PCT No.: PCT/IB2014/001527

§ 371 Date: Dec. 8, 2016

(51) Int. Cl. G01V 1/09; G01V 1/047

(52) U.S. Cl. CPC G01V 1/09; G01V 1/047; G01V 2210/1212; G01V 2210/1295

(57) ABSTRACT

A method for performing a seismic survey using at least one carrier which includes a seismic source. The method includes: deploying each of the at least one carriers by the delivery vehicle, wherein each of the at least one carriers includes: a plurality of supports configured to enable a baseplate to contact ground, wherein the baseplate is formed by each foot of the plurality of supports; a seismic source which includes a lower portion configured to push through unconsolidated materials and configured to contact the ground; and a power source configured to operate the seismic source; and transmitting at least one seismic signal from the seismic source.

### TECHNICAL FIELD

The embodiments relate generally to supporting activities associated with the oil and gas industry and, more particularly, to seismic acquisition activities.

### BACKGROUND

A widely used technique for searching for hydrocarbons, e.g., oil and/or gas, is the seismic exploration of subsurface geophysical structures. Reflection seismology is a method of geophysical exploration to image subterranean features in the earth, which information is especially helpful in the oil and gas industry. Seismic data acquisition and processing techniques are used to generate a profile (image) of subterranean geologic structures. This profile does not necessarily provide an accurate location for oil and gas reservoirs, but it may suggest, to those trained in the field, the presence or absence of oil and/or gas reservoirs. Thus, providing an improved image of the subsurface efficiently is valuable.

The seismic exploration process includes generating seismic waves (i.e., sound waves) directed toward the subsurface area, gathering data on reflections of the generated seismic waves at interfaces between layers of the subsurface, and analyzing the data to generate a profile (image) of the geophysical structure, i.e., the layers of the investigated subsurface. Seismic exploration on land can be conducted using buried sources, for example a downhole dynamite charge, or by using surface seismic sources like vibrators to generate seismic signals useful for geophysical imaging.

Various challenges can exist with respect to land seismic acquisition activities and there may be environmental concerns or societal concerns about using explosives in an area. For example, in some cases it may be desirable or necessary to obtain seismic data in non-optimal locations, e.g., remote location, rough terrain, uneven surfaces, snowy conditions, environmentally sensitive, small operating footprint requirements and the like. Also, in Canada some forested locations in which seismic acquisition activities can be performed use a narrower cut line than is typically used. Additionally, snow is usually removed when the line is cut, but often there may be additional snowfall after the initial cut is made through the forest. Attempting to optimally place a surface seismic source in a narrow footprint, in the snow with a potentially uneven surface can be challenging and potentially being not possible to do or to being performed not as efficiently as desired.

Considering performing seismic acquisition activities on uneven surfaces in more detail, vibrator (source) baseplates are typically fairly large and flat weldments. On an uneven surface a large flat baseplate may not provide a stable platform on which to vibrate. This can lead to the following undesirable possibilities when performing or attempting to perform seismic acquisition activities: (1) the setup of the vibrator platform may tend to slant too much and be unstable; (2) uneven support can lead to a rocking of the vibrator while the vibrator shakes that can produce unwanted sub harmonic seismic energy; and (3) if there is snow, a large flat surface, e.g., the baseplate, may be harder to push down through the snow such that the baseplate may not be well coupled to the earth.

Accordingly, it would be desirable to provide methods and systems that avoid the afore-described problems and drawbacks.

### SUMMARY

According to an embodiment, there is a method for performing a seismic survey using at least one carrier which includes a seismic source, the method comprising: deploying each of the at least one carriers by a delivery vehicle, wherein each of the at least one carriers includes: a plurality of supports configured to enable a baseplate to contact ground, wherein the baseplate is formed by each foot of the plurality of supports; a seismic source which includes a lower portion configured to push through unconsolidated materials and configured to contact the ground; and a power source configured to operate the seismic source; and transmitting at least one seismic signal from the seismic source

According to an embodiment, there is a system configured to perform a seismic survey using at least one carrier which includes a seismic source, the system comprising: a delivery vehicle configured to deploy each of the at least one carriers, wherein each of the at least one carriers includes: a plurality of supports configured to enable a baseplate to contact ground, wherein the baseplate is formed by each foot of the plurality of supports; a seismic source which includes a lower portion configured to push through unconsolidated materials and configured to contact the ground; and a power source configured to operate the seismic source; and the seismic source is configured to transmit at least one seismic signal.

According to an embodiment, there is a method for performing a seismic survey using a plurality of carriers each of which includes a seismic source, the method comprising: deploying the plurality of carriers by a delivery vehicle; decoupling a first carrier from the plurality of carriers from the delivery vehicle; decoupling each carrier from each of the plurality of carriers to which each carrier is attached to, wherein each of the plurality of carriers includes: a plurality of supports configured to enable a segmented baseplate to contact ground; a seismic source which includes a lower portion configured to contact the ground; and a power source configured to operate the seismic source; and transmitting at least one seismic wave from each source.

### BRIEF DESCRIPTION OF THE DRAWINGS

The accompanying drawings illustrate exemplary embodiments, wherein:

FIG. 1 depicts a plurality of attached carriers according to an embodiment;

FIG. 2 shows a plurality of attached carriers detached from a vehicle according to an embodiment;

FIG. 3(a) illustrates a single carrier detached from a plurality of carriers according to an embodiment;

FIG. 3(b) shows an umbilical and a take up reel for use on a carrier or a vehicle according to an embodiment;

FIG. 4(a) shows a carrier according to an embodiment;

FIG. 4(b) depicts a power storage system according to an embodiment;

FIG. 5 illustrates a lift system according to an embodiment;

FIG. 6 illustrates an electronics cabinet according to an embodiment;

FIG. 7 shows a seismic source housing according to an embodiment;

FIG. 8 depicts an alternative support according to an embodiment;

FIG. 9 shows an interior cross-section of a vibrator unit according to an embodiment;

FIG. 10 depicts an actuator according to an embodiment;

FIG. 11 illustrates a land seismic exploration system according to an embodiment;

FIG. 12(a) shows a combined small source and conventional source seismic survey according to an embodiment;

FIG. 12(b) illustrates a plurality of vibrating pairs of seismic sources according to an embodiment;

FIG. 12(c) depicts operating a group of vibrating pairs along a source line according to an embodiment;

FIG. 13 illustrates a method for performing a seismic survey according to an embodiment; and

FIG. 14 shows another method for performing a seismic survey according to an embodiment

FIG. 15 shows another method for performing a seismic survey according to an embodiment.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular feature, structures, or characteristics may be combined in any suitable manner in one or more embodiments.

According to embodiments, and in order to address, among other things, the problems discussed in the Background, methods for performing a seismic survey, and associated systems for performing the methods, are described below in which mobile vibrational sources and carriers can operate on a smaller footprint on uneven terrain more efficiently than conventional systems. For example, according to an embodiment, a seismic survey can be performed in areas covered by unconsolidated materials, e.g., gravel, sand, snow, loose soil, vegetation, mulched branches, trees, etc., which may create or be located on an uneven surface. This seismic survey can be performed by one or more sources incorporated into one or more carriers with a relatively small footprint which can be decoupled from both other carriers and a delivery vehicle which can reduce undesirable noise. Furthermore, according to an embodiment, multiple supports can be used to create baseplates in contact with the ground where the bases of the multiple supports need not create a single continuous baseplate.

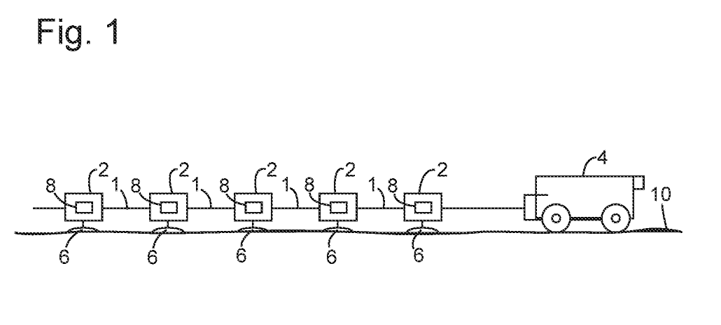

According to an embodiment, there can be one or more carriers 2 each of which has a seismic source 8, e.g., a small, mobile vibratory source, as shown in FIG. 1. The carriers 2 can be linked together in a so-called “daisy-chain” style with one carrier being attached to a delivery vehicle 4, e.g., a truck, a snow mobile or a tractor. This physical linkage, which may be as simple as a tow hitch or more complex as desired, is shown as line 1 between the carriers 2 and vehicle 4. Each carrier 2 also has structures 6 along which the carriers 2 move along the ground 10. Examples of the structures 6 include wheels, metal runners (skis) and/or tracks.

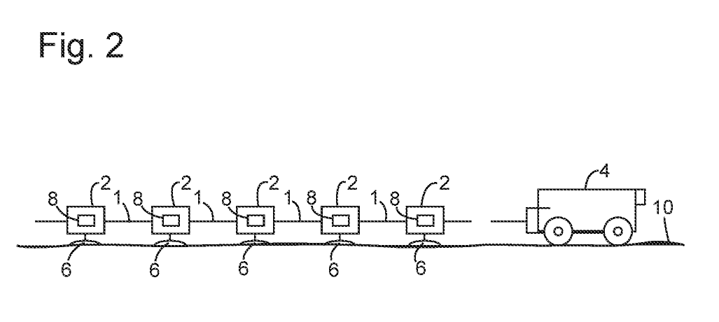

According to an embodiment, the carriers 2 can be detached and left as a group or as a single carrier 2. This can be seen in FIG. 2, in which the five carriers 2 have been delivered by the vehicle 4 and decoupled from the vehicle 4. Having the carriers 2 being decoupled from the vehicle 4 reduces noise, e.g., engine noise, from the vehicle 4 which can be a detractor during seismic activities which use the source(s) 8. Additionally, while shown as being coupled together in FIG. 2, the carriers 2 could alternatively be decoupled from each other as desired to, for example, achieve a desired spacing between the sources 8.

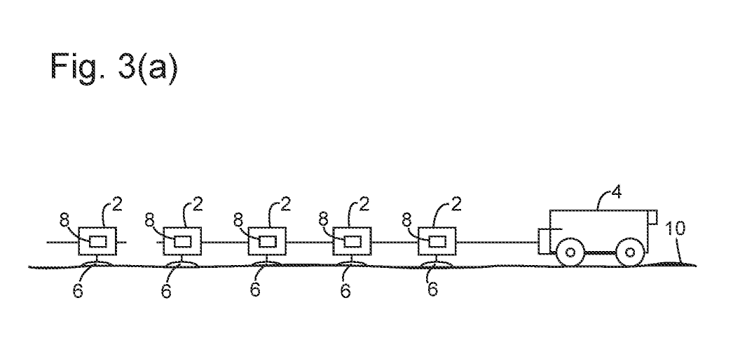

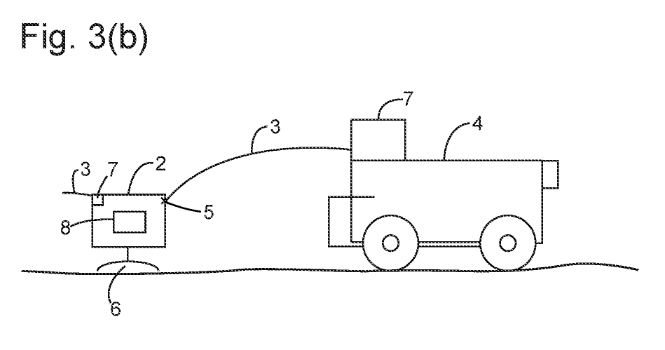

According to another embodiment, as shown in FIG. 3(a), a single carrier 2 can be left alone to operate while the vehicle 4 delivers the rest of the carriers 2 either singly or in various sized groups to other locations. Therefore, according to embodiments, a single source 8 can operate alone or various numbers of sources 8, e.g., one to five or more sources 8, can work together in various firing sequences which may be predefined as desired.

According to an embodiment as shown in FIG. 3(b), the carriers 2 and vehicle 4 can also have an umbilical 3 which can include cables for both data transmission, electrical power transmission and pneumatic power transmission between the vehicle 4 and one or more of the carriers 2 to support various power, data needs or command and control instructions as desired. Various ways in which power and data can be used by the carrier 2 and the source 8 are described in more detail in the various embodiments described below. FIG. 3(b) shows both the carrier 2 and the vehicle 4 having a take up reel 7 which can take up or let out the umbilical 3. Furthermore, there can be a connector 5 on each carrier 2 for the umbilical 3 to plug into. As needed, the umbilical 3 can have a mating connection to connect to the connector 5. Various connection methods can be used as desired.

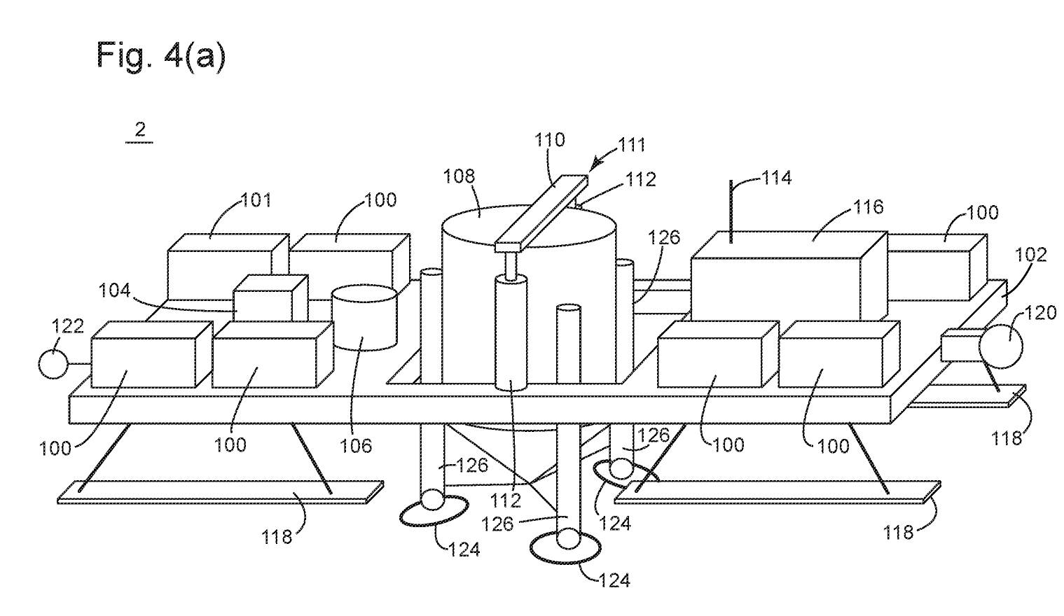

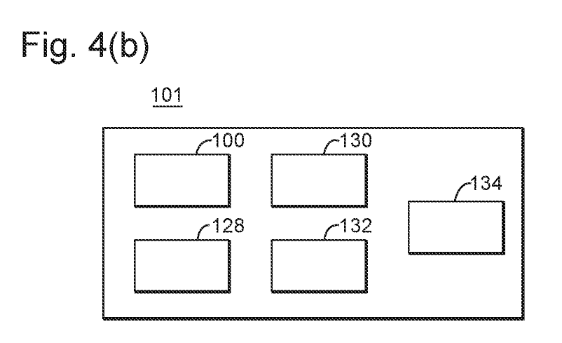

According to an embodiment, as shown in FIG. 4(a), there is a carrier 2 which can include one or more batteries 100, a frame 102, an air compressor 104, one or more air accumulators 106, a source housing 108, a lift system 111 which may include one or more air cylinders 112, an antenna 114, an electronics cabinet 116, a plurality of, e.g., four, runners/wheels/tracks 118, a hitch 120 and a receiver 122 for the hitch 120.

Additionally, hitch 120 and the receiver 122 for the hitch 120 (which can be a hitch from another carrier) can be configured to allow a daisy-chain of hitches to be towed or positioned as shown in, for example, FIG. 1. The connection for the hitch 120 can include a U-joint for improved maneuverability of the carrier(s) 2 and/or vehicle 4. The skis/wheels/tracks 118 can be changed from one option to another option as desired, e.g., the carrier 2 can be deployed with wheels and then changed to skis for off-road use on snow covered ground.

According to an embodiment, the source housing 108 can be attached to a plurality of supports 126 each of which have a foot 124. While FIG. 4(a) shows three supports 126 and three feet 124, it is to be understood that other combinations of supports 126 and/or feet 124 could be used, e.g., four supports 126 and four feet 124, additionally various shapes and sizes of feet 124 could be used. According to an embodiment, the various configurations of the feet 124 can be considered to be a baseplate. Alternatively, the portion of the housing 108 which can contact the earth can also be considered to be a baseplate or the combination of the feet and portion of the housing 108 which can contact the earth can be considered to be a baseplate. Additionally, according to an alternative embodiment, the baseplate may be a single piece.

According to an embodiment, the batteries 100 can be used to provide electrical power to the devices which need the electrical power including, but not limited to, the air compressor 104, the lift system 111 and the electronics cabinet 116. The use of batteries 100 as the electrical power source allows for a quiet, e.g., less vibration and noise, power source as compared to a conventionally used vehicle engine. Various types of batteries 100 can be used as desired, such as, lead acid, lithium ion and/or aluminum air batteries. Solar cells or other means to recharge the batteries in place could also be located on the carrier. Alternatively, a supercapacitor (also known as an ultracapacitor) can be used to store energy and supply power which can be recharged when being moved between operating locations. According to an embodiment, another option could be to use inverter generators or flywheel storage devices as the power source. Operating conditions, e.g., temperature, recharging availabilities, battery footprint, weight, etc., can be factors in deciding what type of battery or other charging/power storing systems to use.

According to an embodiment, there is an optional power storage system 101 which incorporates a duty cycle operation can be used. The power storage system 101, as shown in FIG. 4(b), can include various combinations of the power sources/power storage devices, e.g., batteries 100, supercapacitor(s) 128, inverter generators 130, flywheel storage devices 132 and solar cells 134. According to an embodiment, the power storage devices of power storage system 101 can be recharged when the carrier 2 is being relocated to a new position by, for example, power from the vehicle 4 delivered via the umbilical 3 or solar cells 134. This can allow for an extended operation time for the seismic source 8.

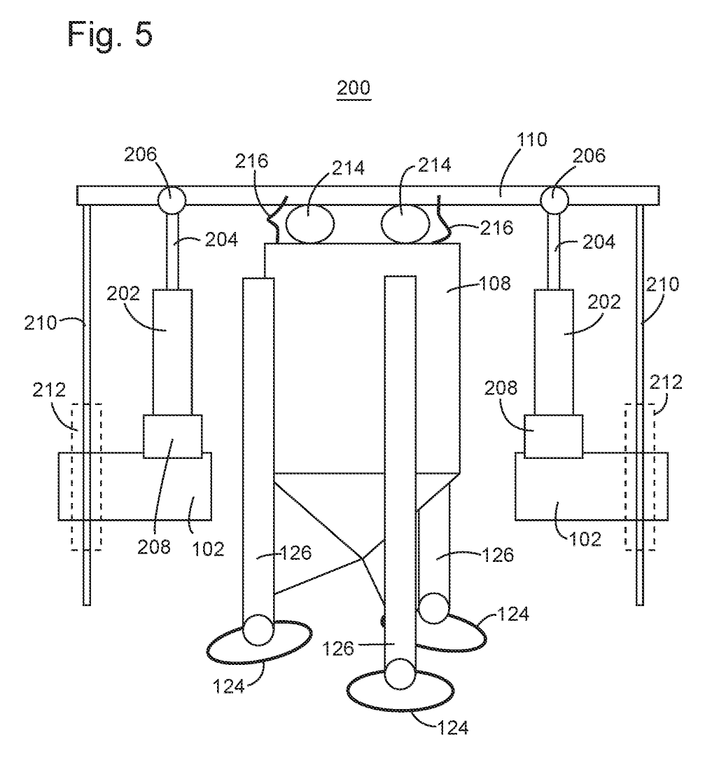

According to an embodiment, the lift system 111 includes cross member 110 and cylinders 112. The air compressor 104, in conjunction with the air accumulator(s) 106 and the lift system 111 can raise and lower the source housing 108 for operating a seismic source, e.g., a vibratory source, to generate seismic waves. In support of raising/lowering the source housing 108 the cross member 110 can be rigidly attached to housing 108. Alternatively, according to an embodiment other lift systems can be used, an example of which is shown in FIG. 5 and described in more detail below.

According to an embodiment, other lift systems, e.g., non-pneumatic, can be used in conjunction with raising and lowering the source/source housing 108 as shown in FIG. 5. The lift system 200 includes the lifting cross member 110 which is connected to two lifting members, e.g., two, ball screw drives or linear actuators 202 with associated rods or shafts 204 which can raise or lower the source housing 108 and vibrator (not shown here as it is located within the source housing 108). Joints 206 and 208 can be used for attaching the ball screw drives or linear actuators 202 to both the lifting cross member 110 and a portion of the carrier frame 102. These joints 206, 208 can also allow for pivot and to reduce side load associated with possible tilt of the carrier 2 and/or source housing 108. Lift guides 210 with associated bushings 212 can be used to allow for a lateral force. Additionally, the lift guides 210 can be attached to the lifting cross member 110 and a portion of the carrier frame 102 with, as desired, some form of a pivot joint (not shown) to allow for a limited range of deviation from a vertical direction. According to an embodiment, the lift system 200 can raise/lower the source housing 108 in combination with one, two, three or more airbags 214 and Kevlar ropes or chains 216 to provide vibration isolation for the source housing 108 (which can also be considered a vibrator driven structure) from both the ball screw drives or linear actuators 202 and the carrier frame 102, when the baseplate is lowered to contact with the earth and hold down weight (carrier weight) has been applied. The Kevlar ropes or chains 216, which may be made of other materials as desired, allow for lifting the seismic source (vibrator) without tearing the airbags 214 and for limiting a tipping amount of the seismic source located within the housing 108.

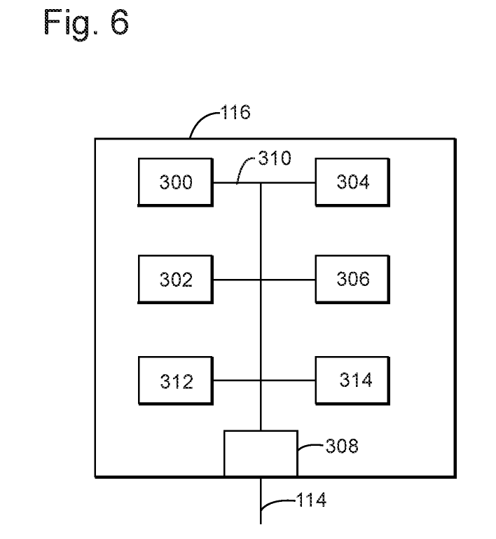

According to an embodiment, the electronics cabinet 116, as shown in FIG. 6, can include a pulse width modulator (PWM) amplifier (amp) 300, a direct current (DC) to DC converter 302, a capacitor bank 304, a controller 306, memory 312, a positioning system 314 and a transceiver 308 which can be connected to antenna 114. The positioning system 314 may include one or more devices/functions able to use Global Positioning System (GPS), Global Navigation Satellite System (GLONASS), Galileo, Beidou, and the like. Controller 306 may include a processor or microprocessor that in conjunction with memory 312 can record time stamped records with accelerometer signals and store them for both later retrieval and integration with the geophone data set. Controller 306 may include interface devices useful for operating/driving the lift system, for example pneumatic valves or other devices.

Additionally, the controller 306 can be configured to compute the weighted sum approximation of ground force by combining reaction mass and baseplate acceleration signals. This computed weighted sum approximation of ground force can then be compared to a reference signal to provide real time quality control (QC) information which may be transmitted to a main recording system management system. Furthermore, components of the electronics cabinet 116 have the capability to transmit and receive command and control functions, as well as other functions. For example, command and control signals for operating and terminating operation of the seismic source 8. These signals can be received through such methods as radio signals, Wi-Fi signals, a local area network (LAN), a system of meshed networks and the like at the antenna 114. Additionally, links 310 represent the ability for electrical power to be delivered and/or information to be exchanged between any of the units within the electronics cabinet 116 as desired.

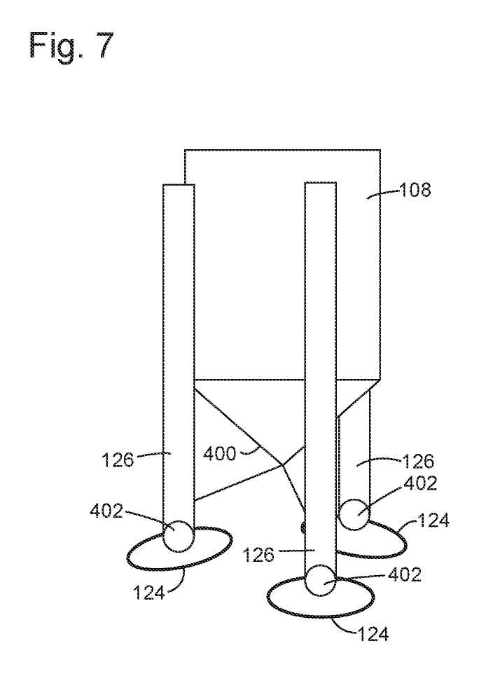

According to an embodiment, the three feet 124 in conjunction with their respective supports 126 form a tripod of support for the source housing 108, an example of which is shown in more detail in FIG. 7. The three feet 124 act in a manner similar to a conventional baseplate which is a single rigid baseplate, but without the limitations. For example, having a plurality of feet 124 which include a joint 402 connecting a foot 124 to a support 126 can allow for rotation of the feet 124 which can provide a more stable support even on many types of uneven surfaces, e.g., rocky terrain or unconsolidated or loose material such as sand, gravel, dirt, snow, mud and the like. These supports 126 and feet 124 allow for a wide base of stability and are designed to allow for better penetration of unconsolidated material which in turn can improve the quality of seismic waves generated by a source within the source housing 108. Additionally, according to an embodiment, the source housing 108 can have a cone shaped portion 400 to also assist in penetrating unconsolidated material and the like. The supports 126 can be reinforced with gussets and the supports 126 can be created from steel or to reduce weight and improve thermal conductivity, created from aluminum, composite materials like carbon fiber could also be used for some parts. Things like feet 124 and foot swivels may be better formed from steel that will resist abrasion and galling rather than aluminum. Additionally, by having multiple feet 124 which are not rigidly connected to each other also allows a more stable platform for operations on uneven surfaces as compared to a single rigid baseplate on such uneven surfaces. According to an embodiment, the shape of the feet 126 can be configured to prevent snagging or minimizing snagging of the feet on brush or other vegetation. Also, an optional brush guard (not shown) can be added to the feet 124 or supports 126.

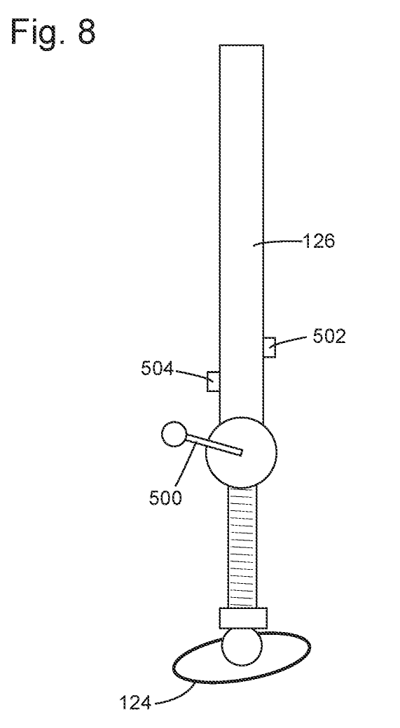

According to an embodiment, as shown in FIG. 8, the leg 126 can be adjustable. As desired, one or more legs 126 may be adjustable. Various methods can be used for adjusting the leg 126. For example, as shown in FIG. 8, the leg 126 can include a manual crank 500 for adjusting the overall length of the leg 126. The manual crank 500 can be used in conjunction with a lead screw to allow for relatively fine adjustments in length. Additionally, a bubble level or inclinometer 502 can be provided to assist in obtaining the desired angle to ensure that the housing 108 will not bump the carrier frame 102.

According to another embodiment, a self-leveling system 504 can be used to adjust the legs 126 such that the carrier 2 and source 8 are as level (parallel) with respect to the surface of the ground. Self-leveling system 540 can also be configured to provide a warning, either visual and/or audible, if there is a risk of the carrier 2 tipping over. The self-leveling system can include a processor, controls, and a motor to automatically adjust the height of the legs 126 as desired.

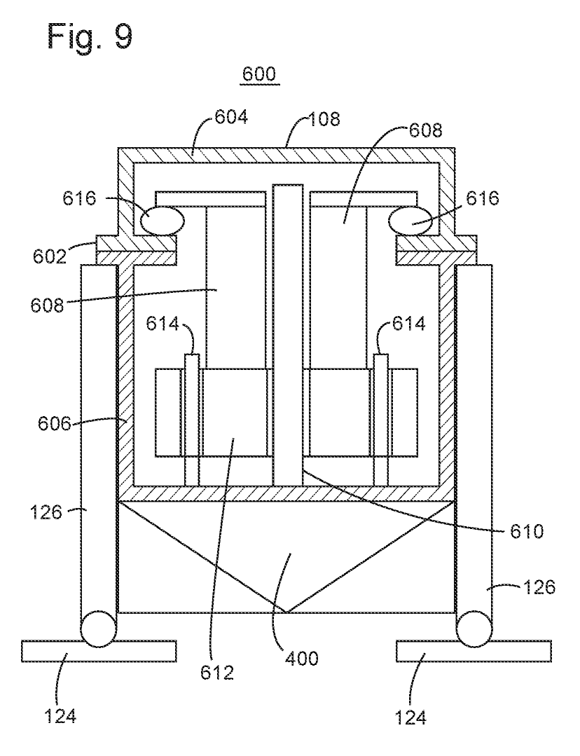

According to an embodiment, FIG. 9 shows an interior cross-section of a vibrator unit 600 (also known as a type of a seismic source). Depicted in FIG. 9 is the vibrator unit 600 includes a housing 108 with a conical lower exterior portion 400, two support legs 124 (with a third leg not shown in this view) and a cover flange 602. Other shapes than conical can be used for the lower exterior portion 400 as desired. The cover flange 602 seals the units and mates a top portion 604 and a lower portion 606 of the housing 108. Inside of the vibrator unit 600 there are electric field windings 608 around a magnetic armature 610. The magnetic armature 610 is shown as being connected to a bottom section of the housing, but alternatively the magnetic armature 610 could be connected to a top portion of the housing or connected to both top portion and bottom section. The electric field windings 608 are connected to a reaction mass 612 whose path of motion is controlled, in a vertical direction by a pair of guides 614.

As the PWM amplifier 300 is instructed by a vibrator control unit 306 current flows into the field winding 608 and generates a force between the field winding 608 and the moving magnet. For example, if a circuit were introduced that flows in a positive direction through the field winding 608, this will cause the field winding rigidly attached to a reaction mass 612 to accelerate upward. At the same time an equal and opposite force would act upon the moving magnet that is connected to the baseplate assembly and create a force that acts downward upon the baseplate (or portion of the source housing) that is also in contact with the ground thereby creating a seismic signal. According to an embodiment, the command signal to the PWM amplifier 300 can be a chirp or a random signal as desired. While the above describes use of a moving magnet actuator, it is to be understood that other forms of actuators can be used in place of the described moving magnet actuator as desired.

According to an embodiment, airbags 616 can be used to support the mass/reaction mass in a gravitational field. The airbags 616 can be connected to a pneumatic controller through a hose (not shown) to ensure that the airbags 616 are properly inflated. Additionally, there can be a linear variable differential transformer (LVDT) (not shown) between the magnetic armature 610 and the mass as well as an accelerometer on the reaction mass 612 and an accelerometer on the housing 108. Oil or other cooling fluid can also be placed within the housing 108 for desired heat transfer characteristics. As the housing 108 is sealed, the chance for having an undesirable oil spill is also greatly reduced. Airbags 616 in addition to supporting the reaction mass 612 in a gravitational field, can provide a compliant volume for the expansion of any cooling fluid that is sealed in housing 108. Alternatively, rather than using the airbags 616 as a compliant volume to accommodate cooling fluid volume changes, a separate compliant chamber, e.g., a metal bellows, could be used as a fluid expansion chamber which would also prevent the buildup of excessive fluid pressure inside the housing 108. Other cooling options are possible.

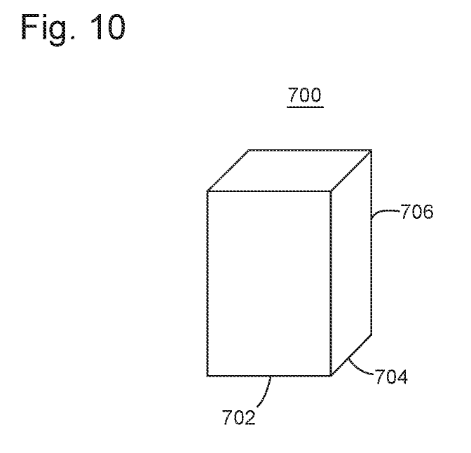

According to an embodiment, as shown in FIG. 10, the actuator 700 can be a linear electric moving magnet actuator packaged into a size of approximately 200 mm width 702 by 200 mm length 704 with a height 706 of 300 mm. Alternatively, other size dimensions can be used. The weight of the actuator 700 can be approximately 30 kg, however other weights can also be used. The actuator 700 can operate at a 7.5 kN peak and a 5.0 kN continuous force. According to an embodiment, the actuator 700 can have six electric coils in series using six hundred volts under operation. The seismic waves generated can be in the 12-150 Hz range when operating with a peak force of 5 kN when using a 250 kg reaction mass. The stroke can be approximately seven mm from peak to peak. However, if a longer stroke is required, a commutating linear motor with a multi-pole magnet, for example, could be used. This results in a calculated total sweep time of 4.4 hours in a colder temperature and 14.7 hours during moderate temperatures assuming that a reasonable number of lead acid batteries are used as energy storage devices for each vibratory system.

Allowing for a 50% duty cycle to allow for moving, the operating time of operation is expected to be in the range of 9 hours (minimum) during colder temperatures. This operation time also assumes approximately an 80% efficiency of the PWM amplifier 300 and the DC to DC converter. Alternatively, the batteries can be of sufficient capacity to allow the unit to operate for a day's work, e.g., 6-12 hours. The various sizes, shapes, weights and other values are just examples of a linear electric moving magnet actuator which are not to be considered limiting as other dimensions and values can also be used in the various embodiments described herein as desired as well as a different actuator.

Examples of operating temperatures include, but are not limited to, −40° C. to +60° C., with cold temperatures being considered to be −10° C. and below. Numbers provided in this example are associated with lead acid batteries, however, as described above, other types of batteries can be used which would provide different operating parameters. According to an embodiment, the batteries can then be removed and replaced for the next operating time period. Additionally, according to an embodiment, rechargeable batteries can be used and recharged for repeat use. Additionally, according to an embodiment, a thermal blanket or other form of insulating box (not shown) can be used for lead acid batteries in some cold environments as desired. Heat generated by any of the heat generating sources on the carrier 2, e.g., PWM amplifier 300, could be directed towards the batteries 100 to keep them warm.

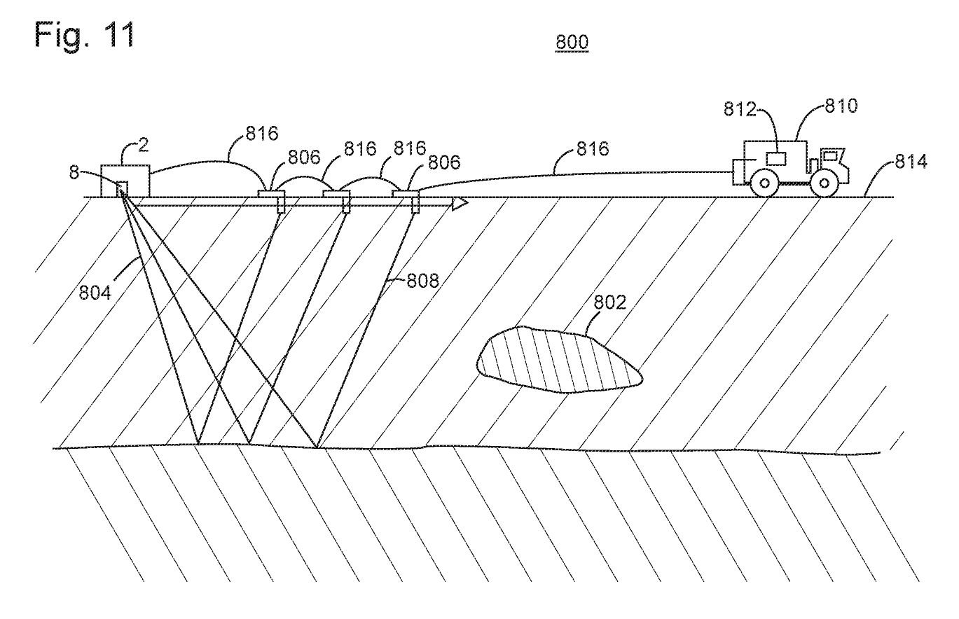

Embodiments described herein associated with the carriers 2 can be used in support of land, transition zone or marine seismic exploration systems for transmitting (or imparting) and receiving seismic waves intended for seismic exploration. An example of such a land system is shown in FIG. 11. FIG. 11 depicts a land seismic exploration system 800 for transmitting and receiving seismic waves intended for seismic exploration in a land environment. At least one purpose of system 800 is to determine the absence, or presence of hydrocarbon deposits 802, or at least the probability of the absence or presence of hydrocarbon deposits 802. System 800 includes a source 8 operable to generate a seismic signal (transmitted waves 804), a plurality of receivers 806 (e.g., geophones) for receiving seismic signals 808 and converting them into electrical signals, and seismic data acquisition system 812 (that can be located in, for example, vehicle/truck 810) for recording the electrical signals generated by receivers 806. Source 8, receivers 806, and data acquisition system 812 can be positioned on the surface of ground 814, all of which can be interconnected by one or more cables 816 or via wireless communications or recorded by autonomous receiver nodes. FIG. 11 further depicts a single source 8, but it should be understood that there can be a plurality of sources 8 on a plurality of carriers 2 as desired.

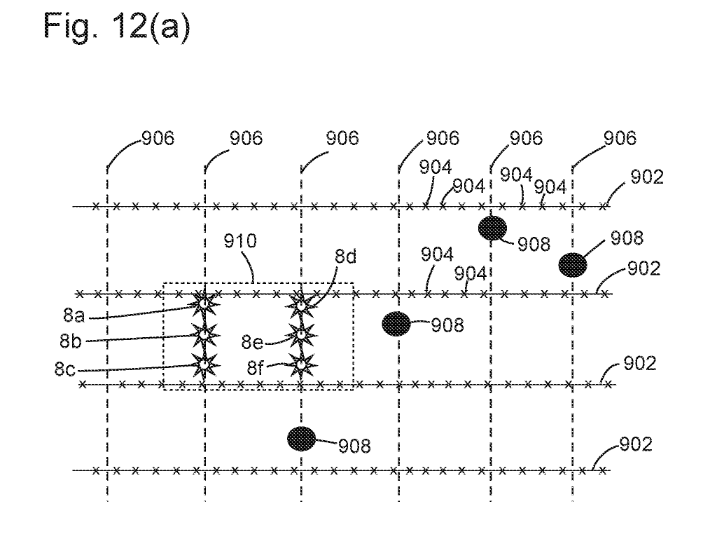

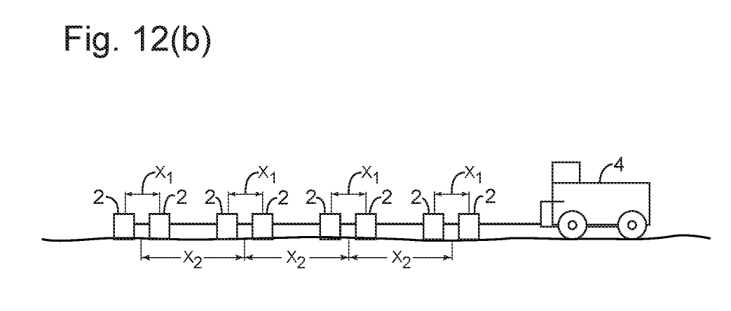

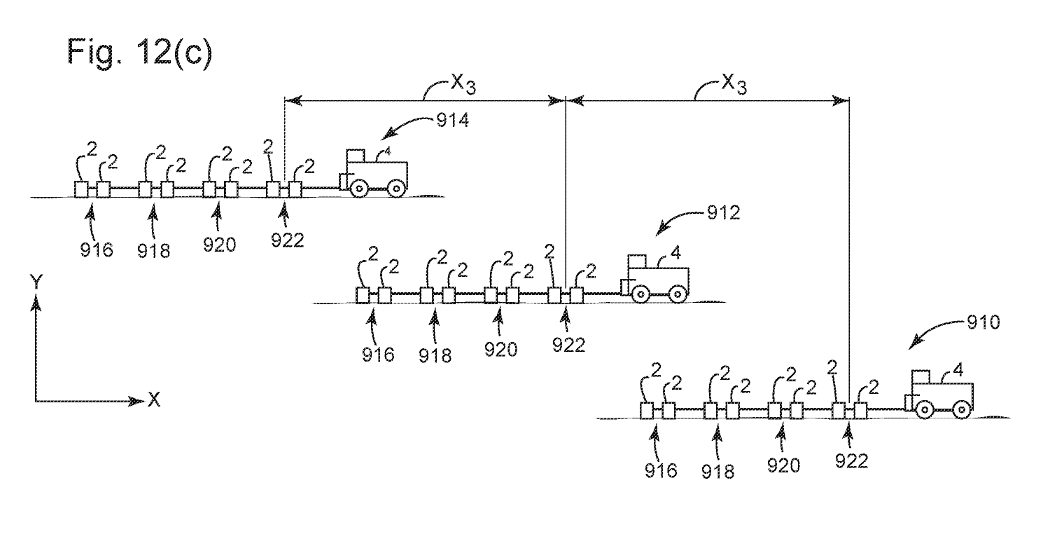

According to an embodiment, the carriers 2 with their seismic sources 8 could be used simultaneously during a seismic survey with conventional seismic sources. An example of this format of a seismic survey 900 is shown in FIG. 12(a). Seismic survey 900 is shown with a plurality of receiver lines 902 which include a plurality of receiver/geophone stations 904 (depicted by all of the “X”s even though only some of the Xs are labelled to not overly crowd FIG. 12(a)) and a plurality of source lines 906. Located in various positions on the plurality of source lines 906 are a number of conventional sources 908 and a number of seismic sources 8a-f. As described above, the seismic source(s) 8 can be delivered via carrier(s) 2 and generate a footprint of use which is smaller than the footprint size used by conventional seismic sources 908. For example, it may be desirable to use seismic sources 8 within area 910, which may be an environmentally sensitive area or an area with an uneven surface to allow for better source to surface contact, as compared to conventional seismic sources 908.

According to an embodiment, various predefined sweep schedules can be generated and implanted using the systems described herein associated with the seismic sources 8 (in conjunction with or not the conventional seismic sources 908) as desired. The seismic sources 8 (and 908 as desired) can be utilized together as an array where their outputs are synchronized to one another. The array elements can generate the same frequency or frequencies at a same time or independently where, for example, each seismic source 8 (and 908 as desired) emits a unique frequency simultaneously. For more information regarding carrying out seismic operations using a series of seismic pickups and sources simultaneously, the reader is directed to U.S. Pat. No. 6,714,867 the contents of which are hereby incorporated by reference.

As described above, the carriers 2 with their smaller sources 8 have a smaller than conventional footprint. According to an embodiment, the sources 8 can be used as a so-called “infill” source where the carriers are detached in designated areas and vibrate on command while a conventional survey may occur simultaneously or during a same time frame. Alternatively, these sources 8 can also be used as the primary sources to conduct a seismic survey in a conventional method. This can be done by delivering a plurality of carriers 4 as desired, and then activating their respective sources 8 either simultaneously or as orthogonal sources or in groups of sources where more than one source 8 executes the same sweep at a same time which builds up signal strength. An example of this is shown in FIG. 12(b) in which vehicle 4 has delivered eight carriers 2 in groups of two carriers which are also known as so-called “vibrating pairs”. A same distance X₁ is used for the distance between each pairing of carriers and another same distance X₂ is used between the center point of each pairing of carriers.

According to another embodiment, a vehicle 4 towing a plurality of carriers 2 operating along a source line can be used as shown in FIG. 12(c). As shown in FIG. 12(c) there is a first operating position 914, a second operating position 912 and a third operating position 910 of the carriers 2 each of which are along a same shot line. At a first time, each of the four vibrator pairs 916, 918, 920 and 922 shake for a predetermined time, e.g., sixteen seconds. Additionally, each of the sweeps associated with a vibrator pair 916, 918, 920 and 922 can be encoded such that their associated generated seismic signals can be separated in processing. At a second time, the vehicle 4 has moved the carriers 2 to the second operating position 912 for the vibrator pairs 916, 918, 920, 922 to operate. At a third time, the vehicle 4 has moved the carriers 2 to the third operating position 910 for the vibrator pairs 916, 918, 920, 922 to operate. The distance traveled between each of the three operating positions 910, 912 and 914 is preferably a same distance as shown by distance X₃. This process can be repeated as desired. While the three different positions 914, 912 and 910 show being offset, this offset was created to emphasize different locations along a same source line for operating over time and as such there is no offset in the Y direction only in the X direction over time as shown in FIG. 12(c) until such time as the vehicle 4 and carriers 2 move to another shot line. Additionally, when carriers 2 with their sources 8 are used in a conventional shooting mode, the sweeps could be swept sine waves in a range of 5-100 Hz for a time period of around sixteen seconds, or pseudorandom signals that are band limited to a 5-100 Hz bandwidth for a similar time period could be used. Alternatively, ranges up to 300 Hz or so can also be used for the swept sine waves and/or pseudorandom signals as desired.

According to embodiments, the carrier 2 and seismic source 8 can be configured in various shapes and sizes to have a smaller footprint than conventional source delivery vehicles. This smaller footprint allows for delivering and operating carrier 2 with source 8 in source lines which have a width of 2.5 m or less or through narrow receiver cut lines. For example, the source 8 can be a 5 kN vibrational source. In use, a grouping of eight of these 5 kN vibrational sources operating at three meter intervals in terms of signal to ambient noise would perform similarly to or perhaps better than a conventional 40-60 kN diesel powered hydraulic vibrator shaking at 25 meter intervals. In other words, embodiments allow for the compensation of the lower peak source output by employing higher source spatial sampling in conjunction with less source generated noise while allowing for operations in narrower confines or other areas where a reduced footprint is desirable and/or required.

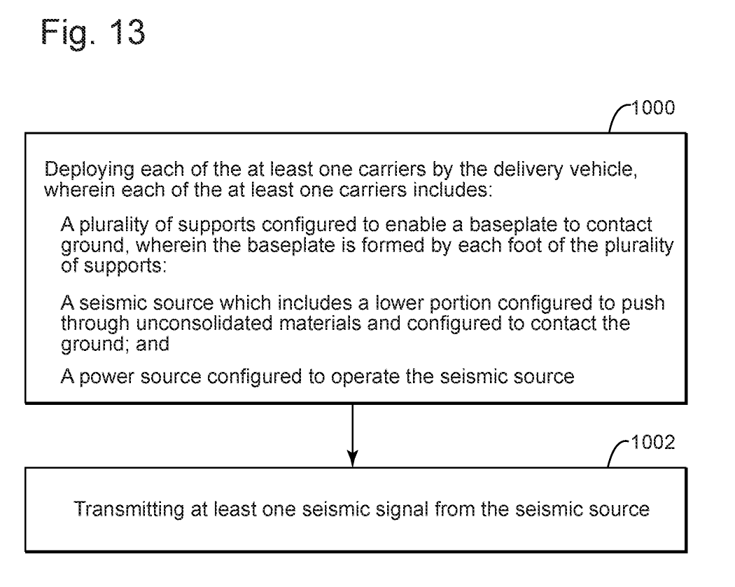

Utilizing the above-described systems according to an embodiment, there is a method for performing a seismic survey using at least one carrier which includes a seismic source, wherein each of the at least one carriers are optionally towed by a delivery vehicle as shown in FIG. 13. The method includes: at step 1000, deploying each of the at least one carriers by a delivery vehicle, wherein each of the at least one carriers includes: a plurality of supports configured to enable a baseplate to contact ground; a seismic source which includes a lower portion configured to push through unconsolidated materials and configured to contact the ground; and a power source configured to operate the seismic source; and at step 1002, transmitting at least one seismic signal from the seismic source.

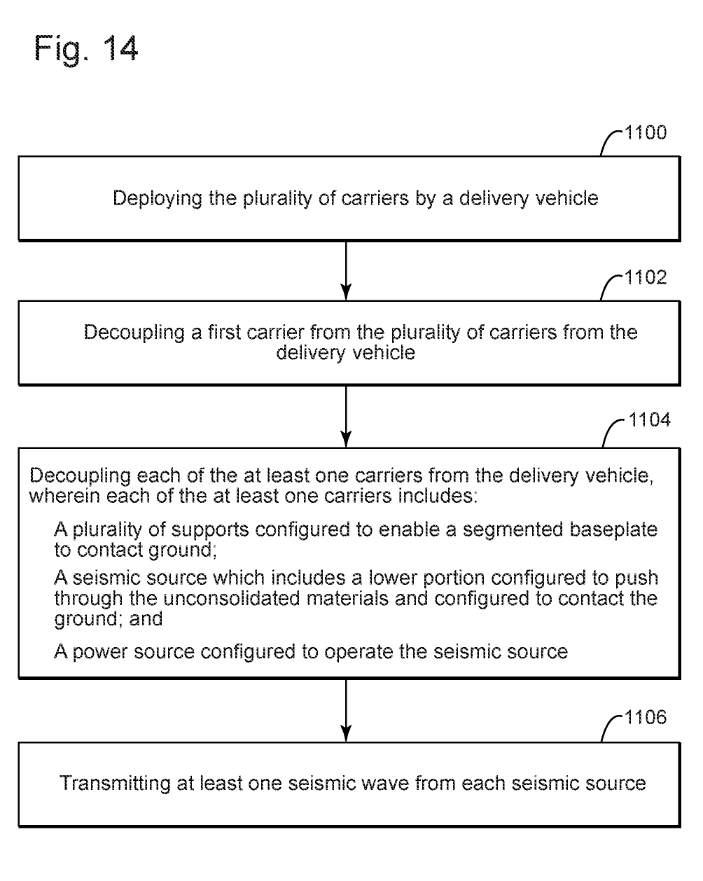

Utilizing the above-described systems according to an embodiment, there is a method for performing a seismic survey using a plurality of carriers each of which includes a seismic source as shown in FIG. 14. The method includes: at step 1100, deploying the plurality of carriers by a delivery vehicle; at step 1102, decoupling a first carrier from the plurality of carriers from the delivery vehicle; at step 1104, decoupling each carrier from each of the plurality of carriers to which each carrier is attached to, wherein each of the plurality of carriers includes: a plurality of supports configured to enable a segmented baseplate to contact ground; a seismic source which includes a lower portion configured to contact the ground; and a power source configured to operate the seismic source; and at step 1106, transmitting at least one seismic signal from each source.

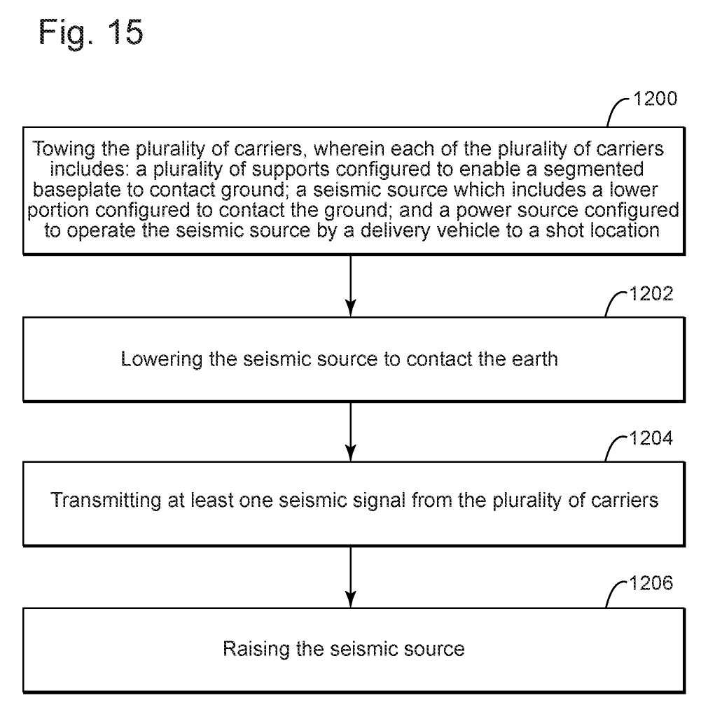

Utilizing the above-described systems according to an embodiment, there is a method for performing a seismic survey using a plurality of carriers each of which includes a seismic source as shown in FIG. 15. The method includes: at step 1200, towing the plurality of carriers, wherein each of the plurality of carriers includes: a plurality of supports configured to enable a segmented baseplate to contact ground; a seismic source which includes a lower portion configured to contact the ground; and a power source configured to operate the seismic source by a delivery vehicle to a shot location; at step 1202, lowering the seismic source to contact the earth; and at step 1204, transmitting at least one seismic signal from the plurality of carriers; and at step 1206 raising the seismic source. These method steps shown in FIG. 15 can be repeated until the seismic survey or a portion thereof is completed.

As described above, various embodiments describe or show the vehicle 4 being used to deliver the carriers 2. However, according to embodiments, other deployment options are available. For example, a helicopter could be used to deliver the carriers 2 as well as vehicle 4. According to an embodiment, the carriers 2 can be of modular design such that portions of the carrier 2 can be delivered to a location for future assembly. The carrier 2 and modular portions of the carrier, e.g., batteries 100, electronics cabinet 116, etc., can be configured to allow for safe and relatively easy picking up and dropping of by the helicopter.

The disclosed embodiments provide systems and methods associated with seismic acquisition operations, e.g., performing a seismic survey. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims. No element, act, or instruction used in the description of the present application should be construed as critical or essential to the invention unless explicitly described as such. Also, as used herein, the article “a” is intended to include one or more items.

1. A method for performing a seismic survey using at least one carrier which includes a seismic source, the method comprising:
deploying each of the at least one carriers by a delivery vehicle, wherein each of the at least one carriers includes:
a plurality of supports configured to enable a baseplate to contact ground, wherein the baseplate is formed by each foot of the plurality of supports;
a seismic source which includes a lower portion configured to push through unconsolidated materials and configured to contact the ground; and
a power source configured to operate the seismic source; and
transmitting at least one seismic signal from the seismic source.

2. The method of claim 1, wherein at least one of the carriers is decoupled from the delivery vehicle and wherein each of the at least one carriers is configured to operate within a source line which has a width ≦2.5 meters.

3. The method of claim 1, wherein the lower portion of the seismic source has a conical exterior.

4. The method of claim 1, further comprising:
generating the at least one seismic signal by an electro-magnetic actuator which operates with a peak force of 7.5 kN and a continuous force of approximately 5.0 kN, wherein the electro-magnetic actuator is a portion of the seismic source.

5. The method of claim 1, wherein the power source is at least one of one or more batteries, one or more flywheel storage devices and one or more supercapacitors.

6. The method of claim 1, further comprising:
operating two or more sources on two or more carriers in a predefined sequence.

7. The method of claim 1, further comprising:
receiving control signals by at least one of the carriers to transmit the at least one seismic signal from the corresponding seismic source.

8. The method of claim 1, wherein the unconsolidated materials includes at least one of snow, sand, gravel, vegetation, mulched branches, trees and loose soil.

9. A system configured to perform a seismic survey using at least one carrier which includes a seismic source, the system comprising:
a delivery vehicle configured to deploy each of the at least one carriers, wherein each of the at least one carriers includes:
a plurality of supports configured to enable a baseplate to contact ground, wherein the baseplate is formed by each foot of the plurality of supports;
a seismic source which includes a lower portion configured to push through unconsolidated materials and configured to contact the ground; and
a power source configured to operate the seismic source; and
the seismic source is configured to transmit at least one seismic signal.

10. The system of claim 9, wherein at least one of the carriers is configured to be decoupled from the delivery vehicle and wherein each of the at least one carrier is configured to operate within a source line which has a width 2.5 meters.

11. The system of claim 9, wherein the lower portion of the seismic source has a conical exterior.

12. The system of claim 9, further comprising:
an electro-magnetic actuator which operates with a peak force of 7.5 kN and a continuous force of approximately 5.0 kN configured to generate the at least one seismic signal, wherein the electro-magnetic actuator is a portion of the seismic source.

13. The system of claim 9, wherein the power source at least one of one or more batteries, one or more flywheel storage devices and one or more supercapacitors.

14. The system of claim 9, wherein two or more sources on two or more detachable carriers are operating in a predefined sequence.

15. The system of claim 9, wherein control signals are received by at least one of the carriers to transmit the at least one seismic wave from corresponding seismic sources.

16. The system of claim 9, wherein the unconsolidated materials includes at least one of snow, sand, gravel, vegetation, mulched branches, trees and loose soil.

17. A method for performing a seismic survey using a plurality of carriers each of which includes a seismic source, the method comprising:
deploying the plurality of carriers by a delivery vehicle;
decoupling a first carrier from the plurality of carriers from the delivery vehicle;
decoupling each carrier from each of the plurality of carriers to which each carrier is attached to, wherein each of the plurality of carriers includes:
a plurality of supports configured to enable a segmented baseplate to contact ground;
a seismic source which includes a lower portion configured to contact the ground; and
a power source configured to operate the seismic source; and
transmitting at least one seismic signal from each source.

18. The method of claim 17, wherein the plurality of supports configured to enable the segmented baseplate to contact ground includes three legs forming a tripod wherein each of the legs has a portion of the segmented baseplate which is not in contact with another portion of the segmented baseplate.

19. The method of claim 17, wherein the size of the footprint for each of the plurality of carriers, each of which includes a seismic source, is smaller than the footprint of a conventional seismic source.

20. The method of claim 19, further comprising:
operating two or more seismic sources on two or more detachable carriers in a predefined sequence in conjunction with at least one conventional seismic source.
